(19) United States
(12) Patent Application Publication
(10) Pub. No.: US 2020/0276885 A1
(43) Pub. Date: Sep. 3, 2020

(54) VENTILATION DEVICE FOR THE INTERIOR COMPARTMENT OF A VEHICLE

(71) Applicant: ILLINOIS TOOL WORKS INC.

(72) Inventor: Florian DÜLL, Röttingen (DE)

(21) Appl. No.: 16/464,516

(22) PCT Filed: Dec. 12, 2017
(86) PCT No.: PCT/US2017/065730

§ 371 Date: May 28, 2019

(30) Foreign Application Priority Data
Dec. 14, 2016 (DE) 10 2016 124 377.9

(51) Int. Cl. B60H 1/34

(52) U.S. Cl. CPC B60H 1/3421

(57) ABSTRACT

A ventilation device for the interior compartment of a vehicle, in particular of an automobile, comprising a holding frame (10) which can be inserted into an installation opening of the vehicle, wherein the holding frame (10) forms a grille-free ventilation opening, and in that multiple ventilation flaps (18) are mounted on the holding frame (10) so as to be pivotable, about a pivot axis (20) running parallel to the center-of-gravity axis (32) thereof, between a closed position, in which they close the ventilation opening and an open position, in which they open up the ventilation opening for the purposes of ventilating the vehicle interior compartment.

### TECHNICAL FIELD

The invention relates to a ventilation device for the interior compartment of a vehicle, in particular of an automobile, comprising a holding frame which can be inserted into an assembly opening of the vehicle

### BACKGROUND

Ventilation devices of this type are known, for example, from EP 2 091 767 B1, WO 2016/081207 A1 or WO 2016/081208 A1. Ventilation devices are used in vehicles, in particular in automobiles, in order to make the outflow of waste air from the vehicle interior compartment possible in the case of a positive pressure. At the same time, the ventilation devices which are also called a return air shut-off are intended to prevent air or pollutants being able to penetrate into the vehicle interior compartment via the ventilation device.

Known ventilation devices have a holding frame which consists, for example, of plastic, with a grille which for example likewise consists of plastic and comprises longitudinal and transverse webs which are arranged in the opening which is formed by the holding frame. Flexible ventilation flaps are frequently fastened, for example, to the transverse webs in a complicated assembly operation, in particular by way of latching. In their rest shape, the flexible ventilation flaps bear against the grille webs and thus close the opening which is formed by the holding frame. Here, the webs of the grille prevent bending of the ventilation flaps which is directed in the direction of the vehicle interior compartment, and therefore an entry of air or pollutants into the vehicle interior compartment. Secondly, if a sufficient positive pressure occurs in the vehicle interior compartment, the ventilation flaps can be bent outward elastically from their rest shape, as a result of which a passage for air which is to be discharged from the vehicle interior compartment is produced.

Known ventilation devices have some disadvantages. Firstly, the ventilation flaps are arranged at an angle by way of corresponding configuration of the webs which form the grille with respect to the plane which is defined by the front side of the holding frame, in order to hold the ventilation flaps in the closed position in the rest state even in the case of a not exactly vertical arrangement of the ventilation device. Said construction increases the installation space of the ventilation device, however. Moreover, in the case of ventilation devices of the above-described type, only a certain proportion of the overall cross section of the opening which is defined by the holding frame can be utilized for the passage of air owing to the design. This reduces the ventilation effect. Inter alia, this is due to the limited opening angle of the ventilation flaps, with the result that zones are formed without a substantial air throughflow, in which zones there is in turn a low pressure. This leads to turbulences which impede the air flow and can lead to an undesired movement of the ventilation flaps. This in turn can lead to the undesired generation of noise. In particular, flexible ventilation flaps have a tendency to perform a fluttering movement, which in turn leads to an undesired fluttering noise and can generate turbulences which impair the ventilation action

### SUMMARY

Proceeding from the above-described prior art, the invention is therefore based on the object of providing a ventilation device of the type mentioned at the outset, which ventilation device makes more efficient and lower noise ventilation possible in a simple way in structural terms and with regard to the assembly.

The invention achieves the object by way of the subject matter of claim 1. Advantageous embodiments can be found in the dependent claims, the description and the figures.

For a ventilation device of the type mentioned at the outset, the invention achieves the object by virtue of the fact that the holding frame forms a grille-free ventilation opening, and that multiple ventilation flaps are mounted on the holding frame so as to be pivotable, about a pivot axis running parallel to the center-of-gravity axis thereof, between a closed position, in which they close the ventilation opening, and an open position, in which they open up the ventilation opening for the purposes of ventilating the vehicle interior compartment.

As explained at the outset, the ventilation device according to the invention serves to avoid a positive pressure in the vehicle interior compartment. If the pressure in the vehicle interior compartment exceeds the ambient pressure by a defined value, the ventilation flaps are pressed out of their closed position, in which they close the ventilation opening, into their open position on account of the positive pressure in the vehicle interior compartment, with the result that air can escape from the vehicle interior compartment into the surrounding area for pressure dissipation purposes.

The holding frame of the ventilation device according to the invention forms a grille-free ventilation opening. The ventilation opening is therefore not interrupted. In particular, no longitudinal or transverse webs are situated in the ventilation opening. Rather, merely the ventilation flaps are arranged in the ventilation opening. Longitudinal or transverse webs for holding the ventilation flaps are not required on account of the pivotable mounting, in particular laterally, of the ventilation flaps on the holding frame. Here, the ventilation flaps are mounted on the holding frame about a pivot axis which is spaced apart in parallel from their center-of-gravity axis. The pivot axis therefore runs eccentrically with respect to the center-of-gravity axis. The center-of-gravity axis is defined by the axis which runs parallel to the pivot axis of the ventilation flaps and through the center of mass (geometric centroid) of the ventilation flaps. The ventilation flaps are each mounted on the holding frame, in particular, about the pivot axis which runs parallel to their center-of-gravity axis, in such a way that they automatically assume the closed position in the state in which they are assembled on a vehicle, and in the case of a pressure equilibrium between the vehicle interior compartment and the surrounding area. The ventilation flaps are therefore prestressed into the closed position. The pivot axes of the ventilation flaps can run, for example horizontally, in the assembled state of the ventilation device.

The effective cross section of the ventilation opening is maximized with respect to the ventilation devices which are known from the prior art by, according to the invention, the ventilation flaps being mounted directly on the holding frame and the longitudinal and transverse webs which are present in the prior art and form a grille in the holding frame thus being able to be dispensed with. At the same time, undesired flow turbulences and, as a result, a reduced efficiency of the ventilation and an undesired development of noise are avoided. By virtue of the fact that the ventilation flaps are mounted pivotably on the holding frame, said ventilation flaps pivot out of the closed position into the open position, unlike the ventilation flaps which were described at the outset and move into the open position by way of elastic bending. As a result, the efficiency of the ventilation is improved further, and undesired turbulences and an undesired development of noise are minimized further. The eccentric pivot mounting of the ventilation flaps in relation to the center-of-gravity axis nevertheless ensures that the ventilation opening is closed securely by way of the ventilation flaps against an entry of air or pollutants into the vehicle interior compartment, if there is no positive pressure in the vehicle interior compartment. A static force is generated which seeks to move the ventilation flaps out of their open position back into the closed position, said static force being sufficiently great for a closure of the ventilation flaps only when a corresponding positive pressure is no longer present in the vehicle interior compartment. By way of a suitable selection of the eccentricity of the pivot axis in relation to the center-of-gravity axis, it can be ensured that the ventilation flaps are situated in the closed position in the case of a freedom from forces, even in the case of a non-vertical assembly position of the holding frame in the vehicle, for example an automobile. Here, the above-described static force can also press the ventilation flaps against one another in the closed position and can thus further improve the seal against the entry of air into the vehicle interior compartment. At the same time, the force (air pressure) which is required for opening the ventilation flaps can be set flexibly in the desired way by way of a suitable selection of the eccentricity of the pivot axis with respect to the center-of-gravity axis.

The holding frame of the ventilation device according to the invention can be configured in one piece, for example produced from a plastic. The production can take place, for example, using a plastic injection molding process. The ventilation flaps can also in each case be configured in one piece, for example produced from a plastic. The production can once again take place, for example, using a plastic injection molding process.

According to one embodiment, the ventilation flaps can each have an aerodynamic profile. The aerodynamic profile can be, for example, an airfoil profile or wing profile. According to a further embodiment, the ventilation flaps can each have a curved profile nose and a profile trailing edge with an acute trailing-edge angle. The profile nose can be curved in a circular manner, in particular. An optimum throughflow of air with a minimum flow resistance is achieved in the open position by way of the aerodynamic profile of the ventilation flaps. At the same time, ventilation flaps having an aerodynamic profile of this type are oriented automatically in the air flow or are stabilized automatically in the air flow, as a result of which the problem of fluttering which was described with respect to the prior art is avoided reliably. Turbulences in the air flow are also minimized in this way. The efficiency of the ventilation device is improved further as a result. This in turn results in further advantages, for example a possible reduction of the dimensions of the holding frame and therefore of the required installation space in the vehicle.

It can be provided according to a further embodiment that the ventilation flaps are in each case of non-flexible form. In the context of this patent application, non-flexible means that the ventilation flaps are not deformed significantly in the case of the forces which occur during operation of the ventilation device, in particular the forces which occur during a ventilation of the vehicle interior compartment. The risk of fluttering and an associated development of noise are minimized further in this way. Slight deformations can be unproblematic, as long as the development of noise is minimized in a desired way.

According to a further embodiment, the ventilation flaps can extend in each case substantially over the entire width of the ventilation opening formed by the holding frame, and can be pivotably mounted in each case on mutually opposite walls of the holding frame. The ventilation flaps can be mounted in each case, in particular, such that they can pivot laterally. For pivotable mounting, the ventilation flaps can have, for example, in each case one pivot pin on their opposite lateral outer faces, the pivot pins being held in each case on pin receptacles which are configured on the walls of the holding frame.

According to a further embodiment, the ventilation flaps, in the closed position, can bear sealingly against an adjacent ventilation flap or against a wall of the holding frame. For example, the ventilation flaps can lie in each case with a lower longitudinal edge (in the assembled state) on an upper longitudinal edge (in the assembled state) of a ventilation flap which is arranged below it in the ventilation opening. The lowermost ventilation flap in the ventilation opening can then lie, for example, with its lower longitudinal edge on a lower wall (in the assembled state) of the holding frame. The longitudinal edges of the ventilation flaps run parallel to the pivot axes of the ventilation flaps. This arrangement prevents that the, in particular, non-flexible ventilation flaps can pivot open inward out of the closed position, and air might therefore pass from the outside into the vehicle interior compartment. The grille which is required for this purpose in the prior art in the ventilation opening is not required to this end. Rather, sufficient security against the entry of air into the vehicle interior compartment can be ensured at all times by way of the abovementioned embodiment, even in the case of the grille-free holding frame according to the invention.

At least some of the ventilation flaps, in particular all of the ventilation flaps, can have a sealing element on at least one edge. The sealing elements can be configured in the form of sealing lips. The sealing elements can likewise consist of plastic, in particular a softer plastic than the ventilation flaps. The sealing elements can be elastic, with the result that they can fulfill their sealing function particularly satisfactorily. They can be molded onto the ventilation flaps, for example, in a two-component injection molding process. Since the ventilation device is intended to close an opening between the vehicle interior compartment and the surrounding area, it has to prevent the entry of air, pollutants or else liquids into the vehicle interior compartment in the closed position. In cases in which, for example, non-flexible ventilation flaps do not provide a sufficient seal, the above-described sealing elements can be advantageous. They provide a secure seal in the closed position and at the same time permit a friction-free movement of the ventilation flaps. Moreover, a damping action can be realized by way of sealing elements of this type, and gentle closure of the ventilation flaps is made possible. They prevent a closing noise which would otherwise occur in the case of an abrupt interruption of the air flow or in the case of a single brief pressure rise, for example when a vehicle door is closed rapidly.

According to a further embodiment in this regard, at least some of the ventilation flaps, in particular all of the ventilation flaps, can have a sealing lip in each case on at least one longitudinal edge, wherein the sealing lips, in the closed position, bear sealingly against an adjacent ventilation flap or against an inner wall of the holding frame. The longitudinal edges of the ventilation flaps run parallel to the pivot axes of the ventilation flaps. In the closed position, sealing lips which are arranged, for example, on the lower longitudinal edges of the ventilation flaps in the assembled state bear in each case sealingly against the upper side of a ventilation flap which is arranged below it in the ventilation opening. Merely the sealing lip of the lowermost ventilation flap bears sealingly against the lower inner face of the holding frame in the assembled state.

According to a further embodiment in this regard, at least some of the ventilation flaps, in particular all of the ventilation flaps, can have in each case one sealing lip in each case on at least two opposite transverse edges, wherein the sealing lips, in the closed position, bear sealingly against mutually opposite inner walls of the holding frame. The mutually opposite transverse edges of the ventilation flaps form outer edges of the ventilation flaps and run perpendicularly with respect to the pivot axes. The corresponding sealing lips bear sealingly against the mutually opposite walls of the holding frame which mount the ventilation flaps pivotably. The seal in the closed position is improved further by way of said sealing lips. It is possible that sealing lips are provided in each case on the upper and/or lower transverse edges of the ventilation flaps, possibly also partially. Sealing sections can be provided on the walls of the holding frame, against which sealing sections the sealing lips then bear. Like the sealing lips, the sealing sections can likewise consist of a softer material in comparison with the material of the holding frame, for example plastic. In particular, the sealing sections can consist of the same material as the sealing lips. Sealing sections of this type facilitate the assembly of the ventilation flaps and can achieve gentler closure of the ventilation flaps and therefore a further minimization of noise.

According to a further embodiment, the ventilation flaps can be coupled to one another by way of at least one coupling bar which synchronizes the pivoting movement of the ventilation flaps between the closed position and the open position. The longitudinal axis of the coupling bar can run perpendicularly with respect to the pivot axes of the ventilation flaps. Here, the coupling bar can be pivotably connected for example centrally to the ventilation flaps, for example to an upper longitudinal edge (in the assembled state) of the ventilation flaps. In the case of a pivoting movement of one ventilation flap, the coupling bar forces the other ventilation flaps to likewise perform said pivoting movement. It serves to homogenize the pivoting movement of the ventilation flaps and therefore to further improve the efficiency, to further reduce turbulences and therefore to further reduce the development of noise. In particular, highly turbulent surroundings with rapidly changing pressure states can lead to pronounced and rapid movements of the ventilation flaps. Here, the cross-sectional shape of the ventilation flaps can be insufficient for stabilization of the ventilation flaps and therefore of the air flow. The coupling bar acts here, with the result that fluttering of the ventilation flaps is avoided reliably. The coupling bar also leads to a more homogeneous distribution of force between the ventilation flaps, which once again improves the opening and closing behavior. The coupling bar can consist, for example, of plastic.

According to a further embodiment, the coupling bar is connected to the ventilation flaps in each case by way of a pivot joint. Latching connections may be suitable, for example, for the pivotable securing of the coupling bar on the ventilation flaps. For example, the coupling bar can have a plurality of C-shaped latching receptacles, into which a cylindrical part of a longitudinal edge of the ventilation flaps engages in a latching manner.

It can be provided according to a further embodiment that, in the installed state of the ventilation device, the center-of-gravity axis of each ventilation flap runs below the pivot axis of the respective ventilation flap and so as to be laterally offset relative to the pivot axis of the respective ventilation flap in the direction of the outer side averted from the vehicle interior compartment. In the state in which it is assembled on a vehicle, the center-of-gravity axis is therefore arranged below and offset laterally to the outside with respect to the pivot axis. In this way, a prestress of the ventilation flaps into the closed position is achieved in a particularly simple way. Moreover, an arrangement of the ventilation device such that it is tilted with respect to the vertical is also possible in this way, the ventilation flaps assuming the closed position in the case of an equalization of pressure between the vehicle interior compartment and the surrounding area.

It can be provided according to a further embodiment that an (imaginary) connecting line between the pivot axes of the ventilation flaps runs at an angle α with respect to an (imaginary) connecting line between the pivot axis and the center-of-gravity axis of each ventilation flap, wherein, for the angle α, the following applies: 10°≤α≤45°. Furthermore, the following can preferably apply: 20°≤α≤35°. The connecting lines are in each case the shortest connecting lines between the respective axes. The connecting lines therefore run, in particular, perpendicularly with respect to the respective axes and/or in a cross-sectional plane with respect to the axes. In the case of a ventilation device which is assembled vertically in a vehicle, the connecting line between the pivot axes of the ventilation flaps is identical to the direction of gravity. Here, the angle α defines the angle, by which the ventilation device can be assembled in a tilted manner with respect to the direction of gravity without the ventilation flaps opening in the case of an equalization of pressure between the vehicle interior compartment and the surrounding area. Moreover, the required force for opening the ventilation flaps and the closing force of the ventilation flaps and therefore the seal on the basis of the lever principle can be set in a flexible manner by way of the spacing between the respective pivot axis and the center-of-gravity axis possibly in connection with the selected angle α

### BRIEF DESCRIPTION OF THE DRAWINGS

The invention also relates to a vehicle, in particular an automobile, comprising at least one installation opening and at least one ventilation device according to the invention inserted into the at least one installation opening.

Exemplary embodiments of the invention will be described in greater detail in the following text using figures, in which, diagrammatically:

FIG. 1 shows a ventilation device according to the invention in accordance with a first exemplary embodiment and in a first operating state, in a perspective rear view,

FIG. 2 shows the view from FIG. 1 in a second operating state,

FIG. 3 shows the view from FIG. 1 in a third operating state,

FIG. 4 shows a front view of the ventilation device which is shown in FIG. 1, in the operating state which is shown in FIG. 1,

FIG. 5 shows the front view from FIG. 4 in the operating state which is shown in FIG. 3,

FIG. 6 shows a cross-sectional view of the ventilation device which is shown in FIG. 1, in the operating state which is shown in FIG. 1,

FIG. 7 shows an enlarged illustration of detail A from FIG. 6,

FIG. 8 shows the illustration from FIG. 6 in a tilted arrangement,

FIG. 9 shows a ventilation device according to the invention in accordance with a second exemplary embodiment and in a first operating state, in a perspective rear view, and

FIG. 10 shows the view from FIG. 9 in a further operating state.

Unless specified otherwise, identical designations denote identical objects in the figures.

### DETAILED DESCRIPTION

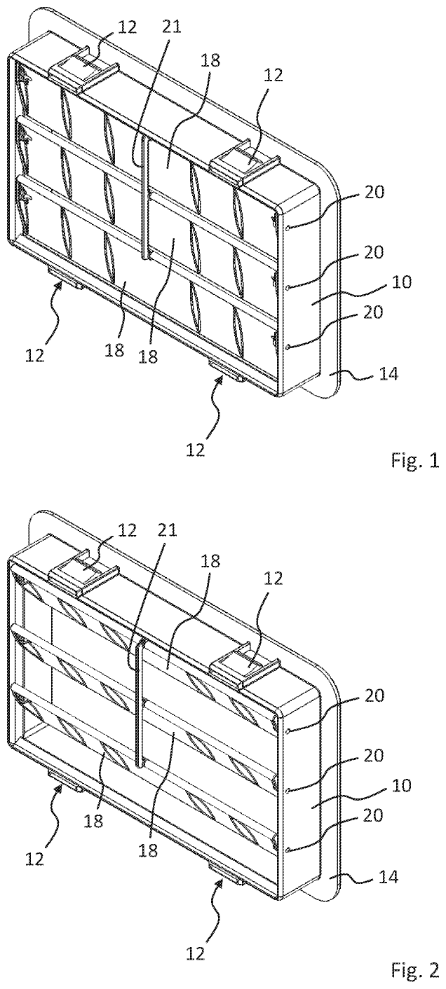

The ventilation device which is shown in FIGS. 1 to 8 in accordance with a first exemplary embodiment has an approximately rectangular holding frame 10 in the example which is shown, on the upper side and underside of which holding frame 10 a plurality of latching projections 12 are configured. For assembly, the ventilation device is inserted with the holding frame 10 into a vehicle opening, for example an opening in an automobile, the latching projections 12 coming into latching engagement with corresponding latching elements of the vehicle opening. A frame plate 14 which runs around the holding frame 10 forms an outer border. The holding frame 10 is a grille-free holding frame. No transverse or longitudinal webs, in particular, are therefore arranged in the ventilation opening 16 which is delimited by the holding frame 10. Rather, three ventilation flaps 18 are situated in the ventilation opening 16 in the exemplary embodiment which is shown in FIGS. 1 to 5, which ventilation flaps 18 are pivotably mounted such that they can be pivoted in each case laterally on mutually opposite walls of the holding frame 10, in particular the shorter walls which run in the vertical direction in FIGS. 1 to 5.

The pivot axes can be seen at the designation 20 in FIGS. 1 to 3. The ventilation flaps 18 in each case have an aerodynamic profile, in particular an airfoil profile. Here, the pivot axes 20 run in each case spaced apart in parallel from the center-of-gravity axis of the ventilation flaps. This achieves a situation where the ventilation flaps 18 are held in the closed position which closes the ventilation opening 16 and is shown in FIGS. 1 and 4, in the case of an identical air pressure in the vehicle interior compartment and the vehicle surrounding area. It can be seen clearly in FIG. 4, in particular, that the ventilation flaps 18 fill the ventilation opening 16 substantially completely here.

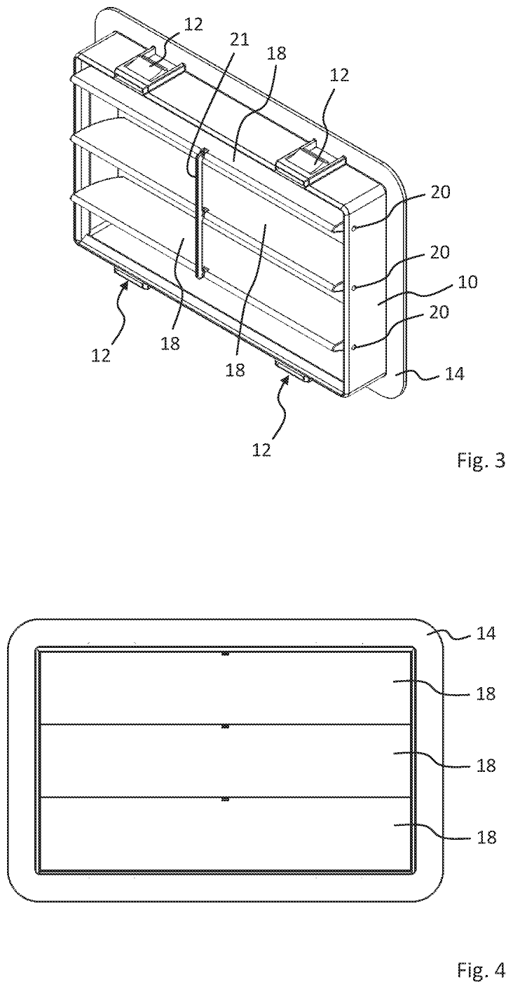

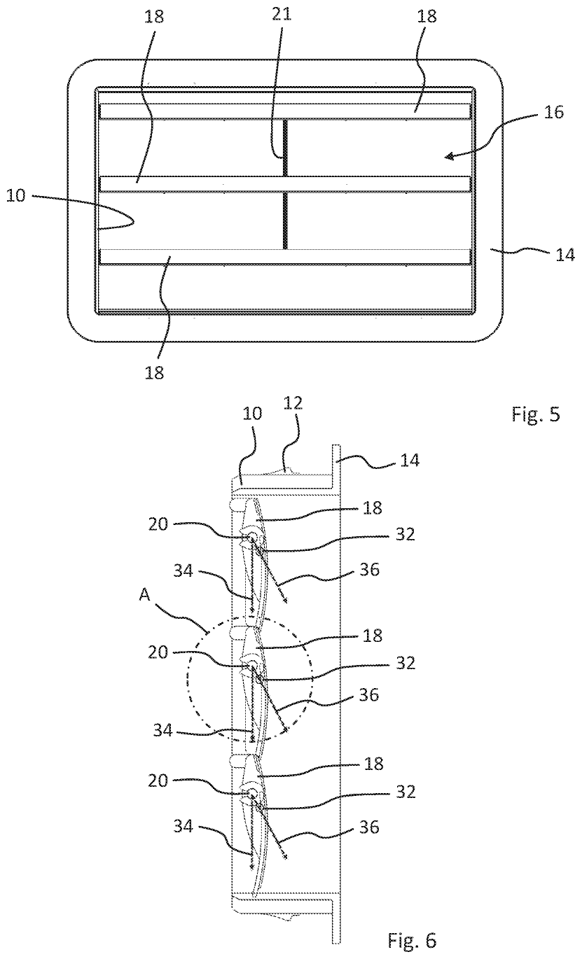

If a positive pressure occurs in the vehicle interior compartment during operation, the ventilation flaps 18 are first of all pivoted open partially into the partial open position which is shown in FIG. 2, and are pivoted open into the completely opened open position in the case of a further prevailing positive pressure, as shown in FIGS. 3 and 5. It can be seen in FIG. 5 that the ventilation opening 16 is open to the maximum extent for the passage of air in the open position, without a grille of the holding frame 10 disrupting the air flow. On account of the aerodynamic profile, the ventilation flaps 18 are oriented automatically in the air flow and assume a position which is as stable as possible. For further improvement, the coupling bar which is shown at the designation 21 in FIGS. 1 to 5 can be provided. The coupling bar 21 is connected pivotably in each case, for example, via a latching connection to an upper longitudinal edge (in the closed position) of the ventilation flaps 18, as can be seen from the figures. It synchronizes the pivoting movement of the ventilation flaps 18, by also forcing the pivoting movement of one ventilation flap 18 onto the other ventilation flaps 18.

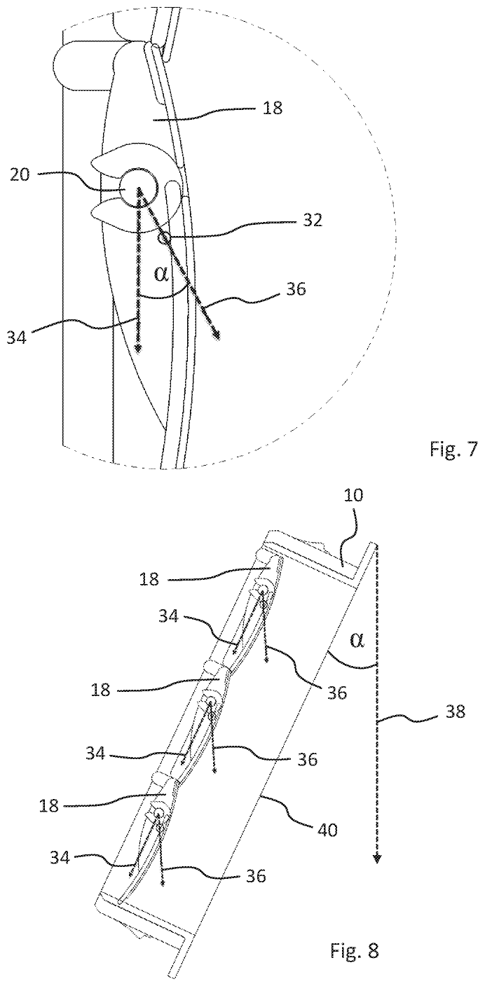

The arrangement between the pivot axes 20 and the center-of-gravity axes 32 of the ventilation flaps 18 is to be described in greater detail using FIGS. 6 to 8. As can be seen, in particular, in the enlarged illustration of FIG. 7, an imaginary connecting line between the pivot axes 20 of the ventilation flaps 18 is illustrated at the designation 34, which connecting line corresponds to the direction of gravity, that is to say the vertical, in the present example. An imaginary connecting line between the respective pivot axis 20 and the respective center-of-gravity axis (shown at the designation 32) of the respective ventilation flap 18 is shown in each case at the designation 36. An angle α lies between the imaginary connecting lines 34 and 36, as illustrated in FIG. 7. Said angle α is between 10° and 45°. The angle α is approximately 30° in the example which is shown. Moreover, it can be seen in FIG. 7 that the respective center-of-gravity axis 32 of the ventilation flaps 18 is arranged offset downward and laterally to the outside, that is to say in the opening direction of the ventilation flaps 18, with respect to the respective pivot axis 20. As illustrated using FIG. 8, moreover, the angle α defines the maximum possible tilting angle during the assembly of the ventilation device, up to which the ventilation flaps 18 remain in the closed position in the case of an equilibrium of pressure between the vehicle interior compartment and the surrounding area. It can be seen correspondingly in FIG. 8 that said maximum tilting angle which is shown in FIG. 8 between the direction of gravity which is shown at the designation 38 in FIG. 8 and the opening plane 40 which is defined by the holding frame 10 and is tilted with respect to the vertical plane corresponds to the angle α.

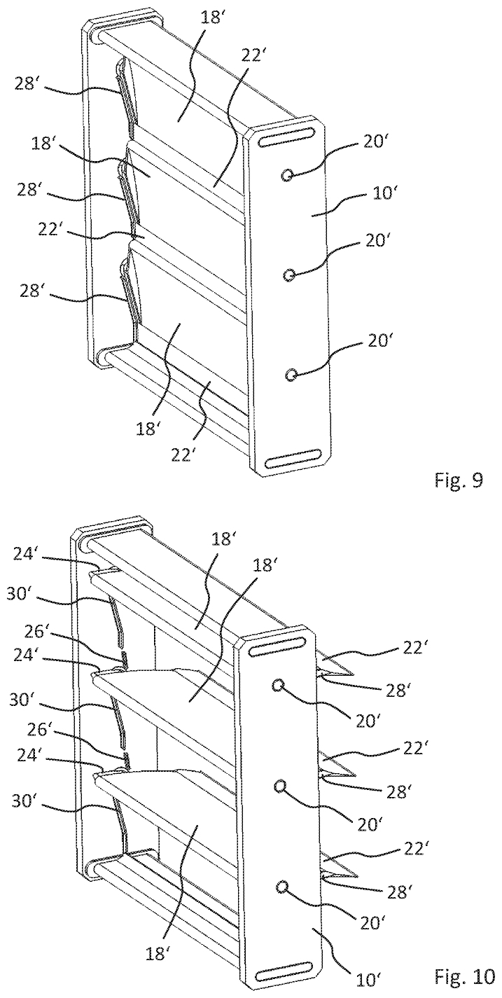

A second exemplary embodiment of the invention is to be described using FIGS. 9 and 10. The ventilation device which is shown in FIGS. 9 and 10 corresponds largely to the ventilation device which is shown in FIGS. 1 to 8. It also has a substantially rectangular holding frame 10′ which delimits a grille-free ventilation opening 16′. In the example which is shown, three ventilation flaps 18′ are once again mounted on mutually opposite walls (in particular the walls which run in the vertical direction in FIGS. 9 and 10) of the holding frame 10′, such that they can be pivoted about pivot axes 20′ between the closed position which is shown in FIG. 9 and the (completely) open position which is shown in FIG. 10. The ventilation flaps 18′ also have an aerodynamic profile, in particular an airfoil profile, in the exemplary embodiment which is shown in FIGS. 9 and 10. Their function corresponds to the function which is described with respect to FIGS. 1 to 8.

For improved sealing of the ventilation opening 16′ in the closed position, the ventilation flaps 18′ in the exemplary embodiment of FIGS. 9 and 10 have in each case one sealing lip 22′ which runs over the entire length of the ventilation flaps 18′ on their lower longitudinal edge in the closed position. The ventilation flaps 18′ can consist, for example, of a plastic. The sealing lips 22′ can likewise consist of a plastic, for example, but of a softer plastic than the ventilation flaps 18′. In the closed position which is shown in FIG. 9, the sealing lips 22′ of the two upper ventilation flaps 18′ bear in each case sealingly against the upper longitudinal edge of the ventilation flap 18′ which is situated below them. The sealing lip 22′ of the lowermost ventilation flap 18′ bears sealingly against the lower wall of the holding frame 10′.

Moreover, the ventilation flaps 18′ likewise have sealing lips in each case on their mutually opposite transverse edges. Firstly, sealing lips 24′ which do not extend over the entire length of the transverse edge are provided in each case on the upper transverse edges. In the closed position, said sealing lips 24′ bear on sealing sections which can be seen at the designation 26′ in FIG. 10 against the mutually opposite inner walls of the holding frame 10′ which mount the ventilation flaps 18′ pivotably. Moreover, further sealing lips 28′ which do not extend over the entire length of the transverse edge are in turn provided on the lower transverse edges of the ventilation flaps 18′, which further sealing lips 28′ bear sealingly against the inner walls of the holding frame on sealing sections 30′ in the closed position. The sealing lips 24′ and 28′ together extend in each case substantially over the entire length of the upper and lower transverse edge of the ventilation flaps 18′. The seal of the ventilation opening 16′ in the closed position is improved further by way of the sealing lips 22′, 24′, 28′ in the exemplary embodiment of FIGS. 9 and 10.

In both exemplary embodiments, the holding frame 10, 10′ can consist in one piece of plastic, produced in a plastic injection molding process, for example. The ventilation flaps 18, 18′ of both exemplary embodiments can also consist in each case in one piece of a plastic, once again produced, for example, in a plastic injection molding process. Any sealing lips can be molded onto the ventilation flaps, for example, in a two-component injection molding process, and can consist of a softer plastic in comparison with the ventilation flaps. The sealing sections 26′ and 30′ can also consist of a softer plastic of this type. They can likewise be molded onto the holding frame in a two-component injection molding process.

Although three ventilation flaps 18, 18′ are shown in the holding frame 10, 10′ in the figures, it goes without saying that fewer or more than three ventilation flaps 18, 18′ can also be provided. Moreover, the coupling bar 21 which is shown with respect to the exemplary embodiment of FIGS. 1 to 8 is also possible in the exemplary embodiment of FIGS. 9 and 10. Furthermore, it is possible to dispense with the coupling bar 21 in the exemplary embodiment of FIGS. 1 to 8. The sealing lips which are shown with respect to the exemplary embodiment of FIGS. 9 and 10 can fundamentally likewise be provided in the exemplary embodiment of FIGS. 1 to 8. In turn, the sealing lips can also be omitted in the exemplary embodiment of FIGS. 9 and 10.

### LIST OF DESIGNATIONS

10, 10′ Holding frame
12 Latching projections
14 Frame plate
16, 16′ Ventilation opening
18, 18′ Ventilation flaps
20, 20′ Pivot axes
21 Coupling bar
22, 22′ Sealing lips
24′ Sealing lips
26′ Sealing sections
28′ Sealing lips
30′ Sealing sections
32 Center-of-gravity axis
34 Imaginary connecting line between pivot axes
36 Imaginary connecting line between pivot axis and center-of-gravity axis
38 Direction of gravity
40 Opening plane

1. A ventilation device for the interior compartment of a vehicle, comprising a holding frame (10, 10′) which can be inserted into an installation opening of the vehicle, characterized in that the holding frame (10, 10′) forms a grille-free ventilation opening (16, 16′), and in that multiple ventilation flaps (18, 18′) are mounted on the holding frame (10, 10′) so as to be pivotable, about a pivot axis (20, 20′) running parallel to the center-of-gravity axis (32) thereof, between a closed position, in which they close the ventilation opening (16, 16′) and an open position, in which they open up the ventilation opening (16, 16′) for the purposes of ventilating the vehicle interior compartment.

2. The ventilation device as claimed in claim 1, characterized in that the ventilation flaps (18, 18′) each have an aerodynamic profile.

3. The ventilation device as claimed in claim 2, characterized in that the ventilation flaps (18, 18′) each have a curved profile nose and a profile trailing edge with an acute trailing-edge angle.

4. The ventilation device as claimed in claim 1, characterized in that the ventilation flaps (18, 18′) are in each case of non-flexible form.

5. The ventilation device as claimed in claim 1, characterized in that the ventilation flaps (18, 18′) extend in each case substantially over the entire width of the ventilation opening (16, 16′) formed by the holding frame (10, 10′), and are pivotably mounted in each case on mutually opposite walls of the holding frame (10, 10′).

6. The ventilation device as claimed in claim 1, characterized in that the ventilation flaps (18, 18′), in the closed position, bear sealingly against an adjacent ventilation flap (18, 18′) or against a wall of the holding frame (10, 10′).

7. The ventilation device as claimed in claim 1, characterized in that at least some of the ventilation flaps (18, 18′) have a sealing element (22′, 24′, 28′) in each case on at least one edge.

8. The ventilation device as claimed in claim 7, characterized in that at least some of the ventilation flaps (18, 18′) have a sealing lip (22′) in each case on at least one longitudinal edge, wherein the sealing lips (22′), in the closed position, bear sealingly against an adjacent ventilation flap (18, 18′) or against a wall of the holding frame (10, 10′).

9. The ventilation device as claimed in claim 8, characterized in that at least some of the ventilation flaps (18, 18′) have in each case one sealing lip (24′, 28′) in each case on at least two opposite transverse edges, wherein the sealing lips (24′, 28′), in the closed position, bear sealingly against mutually opposite inner walls of the holding frame (10, 10′).

10. The ventilation device as claimed in claim 1, characterized in that the ventilation flaps (18, 18′) are coupled to one another by way of at least one coupling bar (21) which synchronizes the pivoting movement of the ventilation flaps (18, 18′) between the closed position and the open position.

11. The ventilation device as claimed in claim 10, characterized in that the coupling bar (21) is connected to the ventilation flaps (18, 18′) in each case by way of a pivot joint.

12. The ventilation device as claimed in claim 1, characterized in that, in the installed state of the ventilation device, the center-of-gravity axis (32) of each ventilation flap (18, 18′) runs below the pivot axis (20, 20′) of the respective ventilation flap (18, 18′) and so as to be laterally offset relative to the pivot axis (20, 20′) of the respective ventilation flap (18, 18′) in the direction of the outer side averted from the vehicle interior compartment.

13. The ventilation device as claimed in claim 1, characterized in that an imaginary connecting line (34) between the pivot axes (20, 20′) of the ventilation flaps (18, 18′) runs at an angle (α) with respect to an imaginary connecting line (36) between the pivot axis (20, 20′) and the center-of-gravity axis (32) of each ventilation flap (18, 18′), wherein, for the angle (α), the following applies: 10°≤α≤45°.

14. An automobile, comprising at least one installation opening and at least one ventilation device as claimed in claim 1 inserted into the at least one installation opening.

15. A ventilation device for the interior compartment of an automobile, comprising: a holding frame (10, 10′) for insertion into an installation opening, wherein the holding frame (10, 10′) forms a grille-free ventilation opening (16, 16′), wherein multiple ventilation flaps (18, 18′) are pivotably mounted on the holding frame (10, 10′), wherein each ventilation flap is pivotable about a respective pivot axis (20, 20′) between a closed position and an open position, wherein each ventilation flap includes a center of gravity axis (32) formed by an axis that runs parallel to the pivot axis (20, 20′) of the ventilation flap and through a center-of-gravity of the ventilation flap, and which center of gravity axis (32) is offset from the pivot axis (20, 20′), wherein when each ventilation flap is in its closed position the ventilation flaps collectively close the ventilation opening (16, 16′) and when each ventilation flap is in its open position the ventilation flaps collectively open up the ventilation opening (16, 16′) for the purposes of allowing flow therethrough.

16. The ventilation device as claimed in claim 15, wherein each ventilation flap (18, 18′) has an aerodynamic profile.

17. The ventilation device as claimed in claim 16, wherein each ventilation flap (18, 18′) has a curved profile nose and a profile trailing edge with an acute trailing-edge angle.
